(19) United States
(12) Patent Application Publication
(10) Pub. No.: US 2007/0275664 A1
(43) Pub. Date: Nov. 29, 2007

(54) Method and System for Improving Wireless Link Performance

(75) Inventor: Brecken Uhl, Las Cruces, NM (US)

Correspondence Address: PATWRITE LLC, 408 W. MAIN ST., MARSHALLTOWN, IA, 50158-5759, US

(73) Assignee: Signature Devices, Inc., Sunnyvale, CA (US)

(21) Appl. No.: 11/754,997

(22) Filed: May 29, 2007

Related U.S. Application Data
(60) Provisional application No. 60/809,050, filed on May 26, 2006.

(51) Int. Cl. H04B 17/00; H04M 1/00

(52) U.S. Cl. 455/67.11; 455/562.1

(57) ABSTRACT

A system to enhance the performance of bi-directional wireless devices while operating within regulatory parameters utilizes at least two units. Each unit receives a signal from a transceiver. The signal may either be a transmit or receive signal and is sampled using a directional coupler and a power detector. A sample portion is sent to a logical decision device controlling the path the signal will take. Transmissions will be sent to an appropriate antenna for transmitting; however, receive signals will be routed to dedicated receiving antennas or arrays, thus increasing the range. Since each unit is thus enhanced, each user of the present invention receives the benefit without expensive retrofits or re-designs. In another embodiment, a control signal is generating a control circuit and directs the input to the appropriate antenna without the need for the directional coupler, power detector or logical decision device.

### RELATED APPLICATIONS

This application claims priority and herein incorporates by reference U.S. provisional patent application 60/809,050, filed May 26, 2006.

### BACKGROUND OF THE INVENTION

The ability of humans to communicate complex thought patterns is arguably the single most important achievement in our history. Humans are born with the innate ability to talk. The next achievement in human communication came with the ability to communicate in written forms as well as verbal. This took many thousands of years and for thousands of years this marked the state of the art in communication. Other milestones include the printing press and inexpensive papermaking.

In less than 200 years, advances in communication has progressed from the telegraph, telephone, radio, internet to the latest in wireless broadband connections and the future appears to hold many more advances in the area o human communication. Children today can't remember a time without the web and the way we search for information has been revolutionized. Today, many people who are not self employed are able to work from home and other non-traditional workplaces.

While communication advances have been incredible in the past 200 years, wireless communication is only 100 years old. The ability to “cut the wire” has allowed our society to advance to a point where we think in totally different ways than our grandparents or even parents. More and more we think in terms of always being in touch whether it is calling our children on their cell phones to check in on them to being at the beach and still being able to access the web through internet enabled appliances. All of these wireless devices use a portion of the electromagnetic spectrum which necessarily limits the number of devices that can operate at the same time with the same frequency. Of course different devices work with different parts of the electromagnetic spectrum and the operating frequencies determine the operating characteristics of the signal such as “short wave” being able to communicate worldwide to low power IR remotes that only operate in a small area.

Although we can squeeze amazing amounts of information in a given portion of the spectrum, it is still finite and there is a great need to maximize usage of a particular frequency without impinging on other concurrent uses. Early in the history of radio, some people addressed this problem by increasing the power they used to transmit their signal. If your neighbor's use interfered with your signal, you could increase your power which led to “power wars.” This practice of “stepping on” another use was quickly recognized as being potentially destructive and limiting the public's access. The United States realized that the government could play a role in encouraging reasonable access by all users and started to regulate the airwaves.

Today, there are limits to the amount of power that can be used to transmit signals depending on the kind of device being used and the application. Although the rules do allow reasonable access by all, they do it at the expense of the individual user by compromising performance in favor of access. There is a need for a system and method for improving an individual wireless application while remaining within the legal requirements imposed by the government and other regulatory requirements.

### SUMMARY OF THE INVENTION

A system to enhance the performance of bi-directional wireless devices while operating within regulatory parameters utilizes at least two units. Each unit receives a signal from a transceiver. The signal may either be a transmit or receive signal and is sampled using a directional coupler and a power detector. A sample portion is sent to a logical decision device controlling the path the signal will take. Transmissions will be sent to an appropriate antenna for transmitting; however, receive signals will be routed to dedicated receiving antennas or arrays, thus increasing the range. Since each unit is thus enhanced, each user of the present invention receives the benefit without expensive retrofits or re-designs. In another embodiment, a control signal is generating a control circuit and directs the input to the appropriate antenna without the need for the directional coupler, power detector or logical decision device.

Other features and advantages of the instant invention will become apparent from the following description of the invention which refers to the accompanying drawings.

### BRIEF DESCRIPTION OF THE DRAWINGS

FIG. 1 is a block diagram of a unit according to an embodiment of the present invention.

FIG. 2 is a block diagram illustrating an embodiment of a system of use according to the present invention.

FIG. 3 is a block diagram of a unit according to another embodiment of the present invention.

FIG. 4 is a block diagram of a unit according to yet another embodiment of the present invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

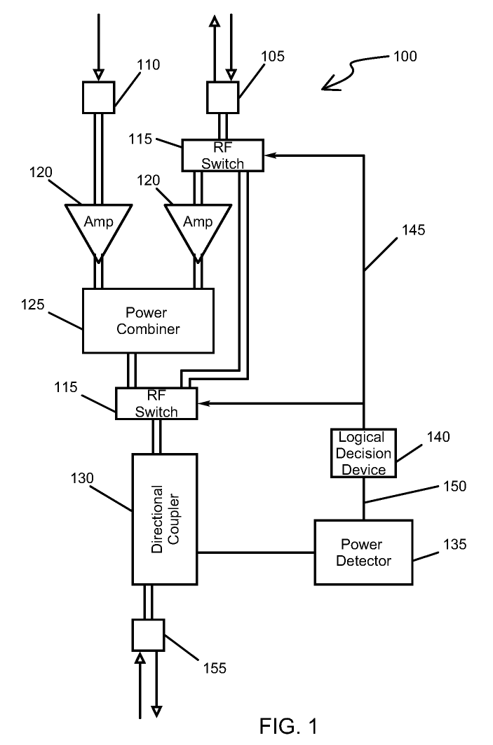

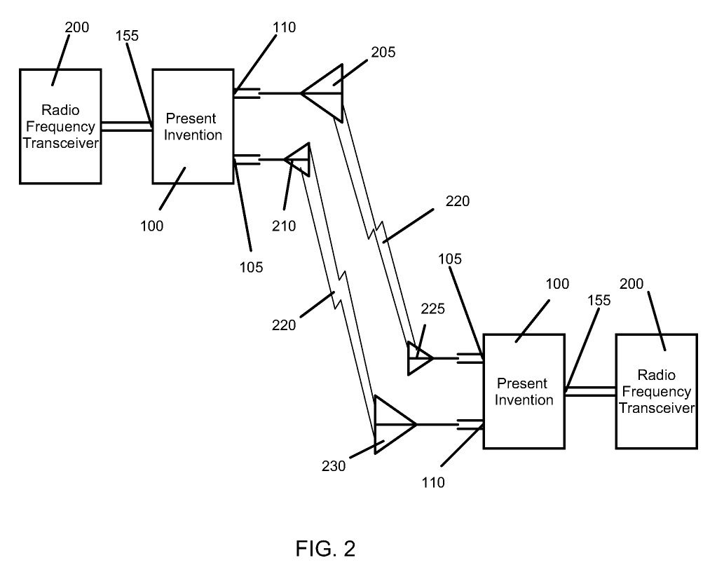

Referring now to FIGS. 1 and 2, a wireless link performance enhancement unit comprises an input connection 155 which is connected to a directional coupler 130. A transceiver 200 is either operating in transmit or receive mode. The signal is fed into a directional coupler 130 which directs the signal flow based on its direction. A sampling portion of the signal is fed to a power detector 135 which in turn feeds a sample to a logical decision device 140. Based on the sampled power, logical decision device 140 controls RF switches 115. If logical decision device 140 determines that transceiver 200 is in transmit mode, the signal is sent to a transmit/receive port 105 which is directed to antenna 210 or 225 respectively ensuring that the signal is within the regulatory parameters set by the federal government. If; however, the device is in receive mode, logical decision device 140 activates all ports 110 and 105 and routes the signal through low noise amplifiers 120 and power combiner 125. This greatly increases performance without the need to redesign or retrofit transceiver 200.

Referring to FIG. 2, a minimum of two users have a unit 100 according to the present invention which is connected to transceivers 200. In the embodiment shown, two antennas are used on each unit 100. Antennas 205 and 230 are high gain antennas connected to receive only ports 110 and antennas 210 and 225 are low gain antennas connected to transmit/receive ports 105. This configuration allows the system to operate within legal limits yet greatly enhance the performance. Wireless signals 220 are exchanged between units 100 by sending a legal transmit from a corresponding low gain antenna to a high gain antenna on the receiving unit. Likewise, when the other unit is receiving, the reverse is true, thus greatly increasing the performance of the system.

Logical decision device 140 can be a simple comparator circuit, a more complex device such as a microprocessor, a field programmable gate array (FPGA) or a complex programmable logical device (CPLD). Power detector 135 may be an analog or digital device as is known in the art. A detected power bus 150 and a state selection bus 145 carry the control signal generated by logical decision device 140 to RF switches 115 to control operation. Detected power bus 150 may be a single wire or a circuit board trace in cases where power detection features a single analog value output, or a set of traces over which a base-two number is conveyed if a digital output is used.

The RF power level produced by power detector 135 is based on the signal power level produced by directional coupler 130. Directional couplers are well known in the art and route power between separate ports based on the direction of the power flow. Directional coupler 130 conveys a reduced amplitude portion of the RF signal produced by RF transceiver 200 to power detector 135 and the magnitude-time function of the signal is presented to logical decision device 140.

Logical decision device 140 detects either transmit or receive mode based on the measures transceiver 200 output power. Logical decision device 140 produces a control signal transmitted by state selection bus 145 which drives the state of one or more of RF switches 115. One set of RF switch 115 positions will result in transmit mode, while another set of RF switch 115 positions will result in receive mode.

RF transceivers produce much higher levels of output power when in transmit mode; therefore when transceiver 200 is in transmit mode, a large amount of RF power will be at an RF transceiver port 155, thus allowing unit 100 to properly ascertain the proper operating mode. The electronic functions necessary to detect and control unit 100 may use any appropriate modulation format as is known in the art. This allows the present invention to be integrated with any known RF transceivers without modification.

In transmit mode, the transmit signal from transceiver 200 is routed to transmit/receive antenna 210 or 225 respectively which bypasses low noise amplifiers 120 which isolates transmit signals from receive only antennas 205 or 230. This ensures that unit 100 will operate within legal power limits. Various methods are available to guarantee operation within legal limits. A common method includes limiting the effective isotropic radiated power (EIRP) of a transmitting device. The EIRP of a transmitter is the product of the maximum directional gain of the antenna with the RF power level produced at the transmit port terminal of the transmitter. In an embodiment of the present invention, scaling of transmitting RF power to meet legal EIRP limits is accomplished by selecting an appropriate external antenna.

In receive mode, all ports including transmit/receive port 105 and receive only port 110 are active. The received signal are amplified by low noise amplifiers 120 and then combined in an RF power combiner 125. External antennas 205 and 230 have a much higher gain than antennas 210 and 225 used in the transmit mode, which greatly improves the range and performance of the system. All RF connections may be micro strip printed circuit board traces or connectorized coaxial transmission lines as is known in the art.

The advantages of the present invention are illustrated by the following example: A transceiver is used which operates with a regulated EIRP of 6 Watts. In such an instance, RF transceivers would be limited to a 6 dB gain antenna. A similar transceiver operating in accordance with the present invention, would be able to utilize antennas with 30 dB of gain (which are readily available in the US 2.4 GHz range). By operating in accordance to the system illustrated in FIG. 2, a 24 dB increase in the effective EIRP which is the difference between the antenna gain value allowed for transmission used prior to the present invention and the system operated in accordance to the present invention. This is an order of magnitude of improvement and is achievable without fundamental change in design of present transceivers.

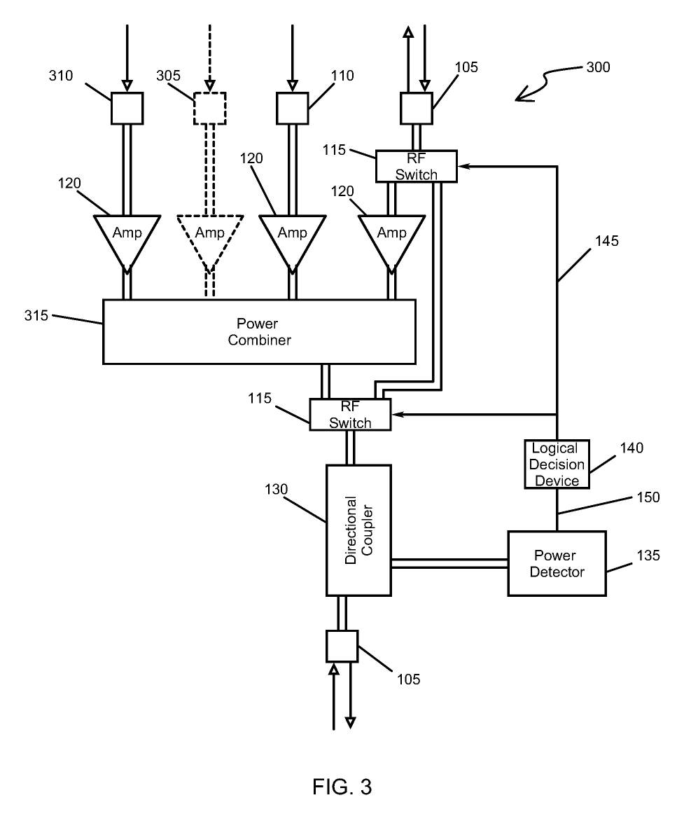

Now referring to FIG. 3, a unit 300 has a plurality of receive only antennas (not shown) feeding into receive only ports 110 through 310 with port 305 representing any number of antennas limited only by practical considerations. A plurality of low noise amplifiers 120 are provided as discussed earlier. Power combiner 315 is used to combine all the signals received from all active ports as discussed above. Although most effective when matched with a similar pair, unit 300 may be paired with unit 100 and still improve overall performance.

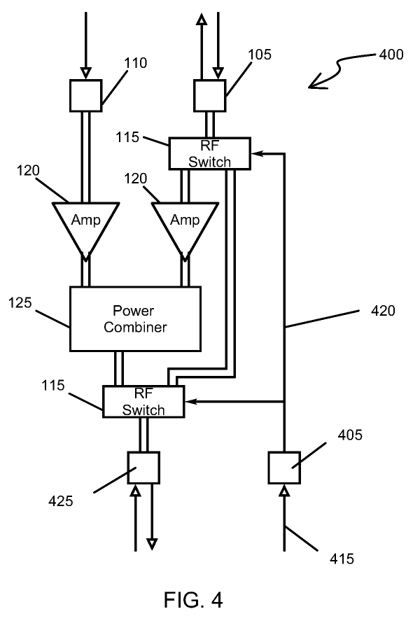

With reference to FIG. 4, a unit 400 is shown in an alternative embodiment has having a direct input from a transceiver (not shown) without the need for a directional coupler, power detector or logical decision device. In this embodiment, a control signal 415 is directly provided by transceiver (not shown) along with the transmit signal if in transmit mode. Control signal 415 may be produced in a simple control circuit (not shown) or simply a function of being fed a portion of the transceiver's (not shown) control signal generated when tranmitting or receiving. An RF connection 425 connects the transceiver (not shown) to unit 400. Control signal connector 405 connects control signal 415 to RF switches 115 to direct signal to bypass low noise amplifiers 120 routing transmit signal directly to low gain antenna thereby operating within acceptable parameters. When in receive mode, all ports 110 and 105 are active routing signal through low noise amplifiers 120 as discussed above. Of course a plurality of antennas could be used in this embodiment as well as discussed above.

Antennas may be any suitable configuration and type such as high-gain, low-gain, narrow-band, wide-band, singularly-polarized and multi-polarized as is known in the art.

Although the instant invention has been described in relation to particular embodiments thereof, many other variations and modifications and other uses will become apparent to those skilled in the art.

What is claimed is:

1. A system for increasing wireless link performance in bi-directional wireless devices while allowing operation within regulatory parameters utilizing at least two units, each unit comprising:
an input from a transceiver;
at least two antennas operatively connected to said unit,
a power detection means for sampling said input to determine whether
said input is a transmit signal or a receive signal; and
a logical decision means for directing said signal to a selected antenna depending on a result of said power detection means.

2. The system for increasing wireless link performance in bi-directional wireless devices while allowing operation within regulatory parameters utilizing at least two units according to claim 1 wherein said power detection means is a binary detector.

3. The system for increasing wireless link performance in bi-directional wireless devices while allowing operation within regulatory parameters utilizing at least two units according to claim 2 wherein said binary detector is an integrated circuit.

4. The system for increasing wireless link performance in bi-directional wireless devices while allowing operation within regulatory parameters utilizing at least two units according to claim 1 wherein said power detection means is an analog detector.

5. The system for increasing wireless link performance in bi-directional wireless devices while allowing operation within regulatory parameters utilizing at least two units according to claim 1 wherein said logical decision means is a comparator circuit device.

6. The system for increasing wireless link performance in bi-directional wireless devices while allowing operation within regulatory parameters utilizing at least two units according to claim 1 wherein said logical decision means is a microprocessor.

7. The system for increasing wireless link performance in bi-directional wireless devices while allowing operation within regulatory parameters utilizing at least two units according to claim 1 wherein said logical decision means is a field programmable gate array device.

8. The system for increasing wireless link performance in bi-directional wireless devices while allowing operation within regulatory parameters utilizing at least two units according to claim 1 wherein said logical decision means is a complex programmable logic device.

9. The system for increasing wireless link performance in bi-directional wireless devices while allowing operation within regulatory parameters utilizing at least two units according to claim 1 wherein one of said at least two antennas is a Yagi-Uda antenna.

10. The system for increasing wireless link performance in bi-directional wireless devices while allowing operation within regulatory parameters utilizing at least two units according to claim 1 wherein one of said at least two antennas is a patch antenna.

11. The system for increasing wireless link performance in bi-directional wireless devices while allowing operation within regulatory parameters utilizing at least two units according to claim 1 wherein said at least two antennas is an antenna array comprising a plurality of receive only antennas.

12. The system for increasing wireless link performance in bi-directional wireless devices while allowing operation within regulatory parameters utilizing at least two units according to claim 1 wherein one of said at least two antennas is a high gain antenna.

13. The system for increasing wireless link performance in bi-directional wireless devices while allowing operation within regulatory parameters utilizing at least two units according to claim 12 wherein an other of said at least two antennas is a low gain antenna.

14. The system for increasing wireless link performance in bi-directional wireless devices while allowing operation within regulatory parameters utilizing at least two units according to claim 11 wherein said plurality of receive only antennas are high gain antennas.

15. A bi-directional wireless link performance enhancement device comprising:
at least two antennas;
a transceiver;
a power detector operatively connected to said transceiver whereby said power detector samples a signal from said transceiver to distinguish a transmit signal from a receive signal; and
a logical decision device operatively connected to said at least two antennas, said transceiver and said power detector whereby said signal is directed to one of said at least two antennas depending on signal type.

16. The bi-directional wireless link performance enhancement device according to claim 15 wherein one of said at least two antennas is a high gain antenna.

17. The bi-directional wireless link performance enhancement device according to claim 16 wherein an other of said at least two antenna is a low gain antenna.

18. A system of enhancing the performance of bi-directional wireless links devices, the system comprising at least two performance enhancement devices; a transceiver operatively connected to each of said at least two performance enhancement devices wherein each of said at least two performance enhancement devices comprising at least two antennas; an input from said transceiver; a control input from said transceiver whereby said input is directed to one of said at least two antennas depending on said control input.

19. The system of enhancing the performance of bi-directional wireless links devices, the system comprising at least two performance enhancement devices according to claim 18 further comprising a control circuit wherein said control input is produced.
